(19) United States
(12) Patent Application Publication
(10) Pub. No.: US 2023/0177437 A1
(43) Pub. Date: Jun. 8, 2023

(54) SYSTEMS AND METHODS FOR DETERMINING AN ERGONOMIC RISK ASSESSMENT SCORE AND INDICATOR

(71) Applicant: Dassault Systemes Americas Corp., Waltham, MA (US)

(72) Inventors: Quentin Bourret, Montreal (CA); Julie Charland, Montreal (CA); David Brouillette, Saint-Lambert (CA); Daniel Imbeau, Montreal (CA)

(21) Appl. No.: 18/063,373

(22) Filed: Dec. 8, 2022

Related U.S. Application Data
(60) Provisional application No. 63/287,240, filed on Dec. 8, 2021.

(51) Int. Cl. G06Q 10/06

(52) U.S. Cl. CPC G06Q 10/0635; G06Q 10/0633

(57) ABSTRACT

Embodiments assess ergonomic risk of causing harm to a worker in a workplace. One such embodiment receives an indication of posture risk level for each of a plurality of digital human models performing a task. In turn, a weighted average of the received indications of posture risk level is determined. This determined weighted average is indicative of ergonomic risk to a real-world worker performing the task in a workplace. Embodiments consider consecutive risk through modifications to weights used in the determining the weighted average.

### RELATED APPLICATION

This application claims the benefit of U.S. Provisional Application No. 63/287,240, filed on Dec. 8, 2021.

The entire teachings of the above application are incorporated herein by reference.

### BACKGROUND

A number of existing product and simulation systems are offered on the market for the design and simulation of objects, e.g., humans, parts, and assemblies of parts, amongst other examples. Such systems typically employ computer aided design (CAD) and/or computer aided engineering (CAE) programs. These systems allow a user to construct, manipulate, and simulate complex three-dimensional (3D) models of objects or assemblies of objects. These CAD and CAE systems, thus, provide a representation of modeled objects using edges, lines, faces, polygons, or closed volumes. Lines, edges, faces, polygons, and closed volumes may be represented in various manners, e.g., non-uniform rational basis-splines (NURBS).

CAD systems manage parts or assemblies of parts of modeled objects, which are mainly specifications of geometry. In particular, CAD files contain specifications, from which geometry is generated. From geometry, a representation is generated. Specifications, geometries, and representations may be stored in a single CAD file or multiple CAD files. CAD systems include graphic tools for representing the modeled objects to designers; these tools are dedicated to the display of complex objects. For example, an assembly may contain thousands of parts. A CAD system can be used to manage models of objects, which are stored in electronic files.

CAD and CAE systems use of a variety of CAD and CAE models to represent objects. Such a model may be programmed so that the model has the properties (e.g., physical, material, or other physics based) of the underlying real-world object or objects that the model represents. Moreover, CAD/CAE models may be used to perform simulations of the real-word objects/environments that the models represent.

### SUMMARY

Simulating an operator, e.g., a human represented by a digital human model (DHM), in an environment is a common simulation task implemented and performed by CAD and CAE systems. Here, an operator refers to an entity which can observe and act upon an environment, e.g., a human, an animal, or a robot, amongst other examples. Computer-based operator simulations can be used to automatically predict behavior of an operator in an environment when performing a task with one or more target objects. To illustrate one such example, these simulations can determine position and orientation of a human when assembling a car in a factory. The results of the simulations can, in turn, be used to improve the real-world physical environment. For example, simulation results may indicate that ergonomics or manufacturing efficiency can be improved by relocating objects in the real-world environment.

Using existing simulation applications, such as the Ergonomic Workplace Design (EWD) application, it is possible to generate a properly postured manikin automatically in a 3D environment thanks to the Smart Posturing Engine™ (SPE™) (Lemieux et al., 2017; Lemieux et al., 2016; Zeighami et al., 2019). The resulting simulated work situation and resulting operator posture (position and orientation) can then analyzed utilizing ergonomic assessment methodologies, such as Ergo4All™ and embodiments described in U.S. Provisional Application No. 63/287,251 filed on Dec. 8, 2021 and the corresponding non-provisional U.S. Pat. Application entitled “SYSTEMS AND METHODS FOR ASSESSING ERGONOMIC RISK,” Attorney Docket No. 4316.1025-001. Such ergonomic assessments enable a sequence of rapid ergonomic evaluations to be performed by manufacturing engineers. With EWD and accompanying ergonomic posture evaluation tools, e.g., Ergo4All™, simulated worker tasks for the operations performed in virtual production lines of a factory can be assessed. However, the amount of ergonomic assessments generated by these tools creates a challenge, namely, determining which problems to tackle first or where to invest time and money to solve the most important ergonomic problems. Manufacturing engineers need to quickly determine which parts of the factory are at risk for the workers and on different levels: factory, department, production line, workstation, worker task, etc.

There are some existing ergonomic assessment methods that yield a score for a given static posture maintained by a worker. RULA (McAtamney & Corlett, 1993) and REBA (Hignett & McAtamney, 2000) are two known such methods, amongst others. However, the scores produced by these methods are specific to each posture analyzed. When analyzing postures along a production line, with REBA for instance, a great many scores are produced. However, no method has been proposed in the literature for combining many scores so as to obtain an overall assessment for the production line as a whole.

Embodiments solve these problems and provide functionality to calculate an ergonomics score for a group of worker tasks (e.g., operation, workstation, production line, factory). This allows users to quickly identify the most problematic points in an area, e.g., workstation, operation, workstation, production line, factory.

One such example embodiment is directed to a computer-implemented method for assessing ergonomic risk of causing harm to a worker in a workplace. Such a method receives an indication of posture risk level for each of a plurality of digital human models performing a task. In turn, a weighted average of the received indications of posture risk level is determined. This determined weighted average indicates ergonomic risk to a real-world worker performing the task in a workplace.

According to an embodiment, each of the plurality of digital human models represents a human with respective anthropometric characteristics. For instance, each digital human model may have unique anthropometric characteristics, e.g., height and weight.

In an example embodiment, determining the weighted average comprises modifying weightings of each received indication of posture risk level as a function of risk level. For instance, an example embodiment may increase the weighting if the posture risk level is high.

In embodiments, the task can be one of a plurality of tasks. In one such embodiment, respective indications of posture risk level, joint at risk, and risk type are received, for each of the plurality of tasks, for each of the plurality of digital human models.

According to an embodiment, the plurality of tasks form an operation, i.e., the performance of the multiple tasks constitutes performing an operation. Such an embodiment determines a weighted average of the received respective indications of posture risk level. The weights utilized in determining the weighted average are a function of the received respective indications of posture risk level, joint at risk, and risk type. The determined weighted average of the received respective indications of posture risk level indicates ergonomic risk of the operation when performed by the real-world worker in the workplace. An embodiment also modifies the weights utilized in determining the weighted average if two consecutive tasks of the plurality of task have both (i) a posture risk level above a threshold and (ii) a same indicated joint at risk.

In another embodiment, a first subset of the plurality of tasks form a first operation, a second subset of the plurality of tasks form a second operation, and the first operation and the second operation are each performed at a workstation in the workplace. Such an embodiment determines a weighted average of the received respective indications of posture risk level. The weights utilized in determining the weighted average are a function of the received respective indications of posture risk level, joint at risk, and risk type and the determined weighted average of the received respective indications of posture risk level indicates ergonomic risk of the workstation.

Another embodiment analyzes a plurality of tasks that form multiple operations. In such an embodiment the multiple operations are performed across multiple workstations that make-up a production line in the workplace. Such an embodiment determines a weighted average of the received respective indications of posture risk level. The weights utilized in determining the weighted average are a function of the received respective indications of posture risk level, joint at risk, and risk type and the determined weighted average of the received respective indications of posture risk level indicates ergonomic risk of the production line, i.e., the production line as a whole.

Further still, another embodiment analyzes ergonomic risk for an entire factory. In such an embodiment the plurality of tasks form multiple operations and the multiple operations are performed across multiple workstations that make-up multiple production lines of said factory. A weighted average of the received respective indications of posture risk level are determined. The weights utilized in determining the weighted average are a function of the received respective indications of posture risk level, joint at risk, and risk type and the determined weighted average of the received respective indications of posture risk level indicates ergonomic risk of the factory.

Embodiments may also provide various outputs indicating the ergonomic risk assessment. For instance, an embodiment may output the determined weighted average. Further, in an embodiment, the outputting reduces ergonomic risk by causing a modification to at least one of: posture, the task, or a workstation at which the task is performed by real-world workers.

Another embodiment is directed to a system for assessing ergonomic risk of causing harm to a worker in a workplace. According to an embodiment, the system includes a processor and a memory with computer code instructions stored thereon. In such an embodiment, the processor and the memory, with the computer code instructions, are configured to cause the system to implement any embodiments or combination of embodiments described herein.

Yet another embodiment is directed to a cloud computing implementation for assessing ergonomic risk of causing harm to a worker in a workplace. Such an embodiment is directed to a computer program product executed by a server in communication across a network with one or more client. The computer program product comprises program instructions which, when executed by a processor, causes the processor to implement any embodiments or combination of embodiments described herein.

As used herein, the terms ‘workers’, ‘workplace’, and ‘ergonomic risk’ refer to real-world domains (including a certain factory or manufacturing environment) while the terms ‘tasks’ and ‘operations’ can refer to either a virtual domain or a real-world domain depending on who is performing an action, e.g., a digital human model, or a real-world worker.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a hierarchical representation of elements that may be assessed for ergonomic risk using embodiments.

FIG. 2 is a flowchart of a method for assessing ergonomic risk of causing harm to a worker in a workplace according to an embodiment.

FIG. 3 is a flow diagram of an example embodiment for assessing ergonomic risk.

FIG. 4 is a hierarchical graph network illustrating relationships between elements that may be evaluated for ergonomic risk using embodiments.

FIG. 5 is a table showing data that may be utilized by embodiments.

FIG. 6 is a simplified diagram of a workflow of a method for assessing ergonomic risk according to an embodiment.

FIG. 7A depicts an ergonomic risk score calculation method that may be utilized in embodiments and FIG. 7B illustrates an example of using the calculation method depicted in FIG. 7A.

FIG. 8A is a flowchart of a method for determining weights used in embodiments.

FIG. 8B are tables illustrating an example use of the method of FIG. 8A.

FIG. 9A is table showing weights used in an embodiment to determine an ergonomic risk score.

FIG. 9B is a table illustrating an example embodiment that utilizes the weights of FIG. 9A.

FIG. 10 is a simplified diagram of a computer system for assessing ergonomic risk of causing harm to a worker in a workplace according to an embodiment.

FIG. 11 is a simplified diagram of a computer network environment in which embodiments of the present invention may be implemented.

### DETAILED DESCRIPTION

A description of example embodiments follows.

Occupational ergonomics have a significant impact in the real-world, e.g., manufacturing world, from Musculoskeletal Disorders (MSD) to product quality issues. As such, assessing ergonomics through the use of models, e.g., DHMs or other such computer-based models, is an important task for organizations, such as product manufacturers.

Functionality and software applications to generate (e.g., EWD and SPE™) and assess (e.g., U.S. Provisional Application No. 63/287,251 filed on Dec. 8, 2021 and the corresponding non-provisional U.S. Patent Application entitled “SYSTEMS AND METHODS FOR ASSESSING ERGONOMIC RISK,” Attorney Docket No. 4316.1025-001) work situations, for instance, a postured manikin in a 3D environment, enable ergonomic evaluations on a large scale. However, when many ergonomic risks are found, as is often the case, it is difficult to determine which risk to tackle first. Embodiments solve this problem by providing methodologies to assess ergonomic risk and provide indications, e.g., scores, of said assessment at different levels, from as high as a factory level to as low as specific actions in a workstation. In this way, embodiments provide a metric that indicates which ergonomic issues are the most problematic and provide guidance to users as to the risks to prioritize.

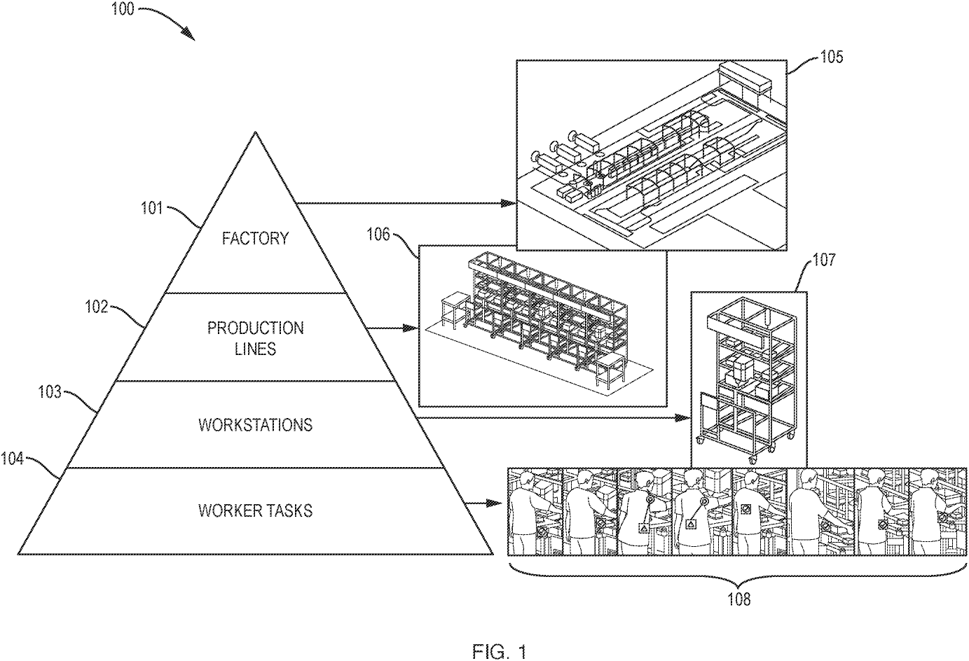

FIG. 1 graphically illustrates a hierarchical structure 100 of elements that may be assessed using embodiments. Specifically, the highest level of the structure 100 is the factory level 101 which encompasses an entire factory 105 (e.g., a certain factory). The next level down is the production line level 102 that is composed of one or more production lines 106 that are part of the factory 105. The production line level 102 encompasses the workstation level 103. In the structure 100 each production line 106 is made of multiple workstations 107. The lowest level of granularity in the structure 100 that may be assessed using embodiments is the worker task level 104. The worker task level 104 is made-up of individual tasks 108 that are performed at a workstation 107.

Ergonomic risk can be determined for the different levels 101-104 of the structure 100 using embodiments. For instance, an indication of factory level 101 risk can be determined using embodiments. Amongst other examples, a factory level 101 indication of ergonomic risk allows a user, who for instance operates multiple factories, to determine where to prioritize improvements, e.g., the factory with the highest ergonomic risk. In turn, said user can evaluate the identified factory to determine the highest risk at the production line level 102, workstation level 103, and worker task level 104.

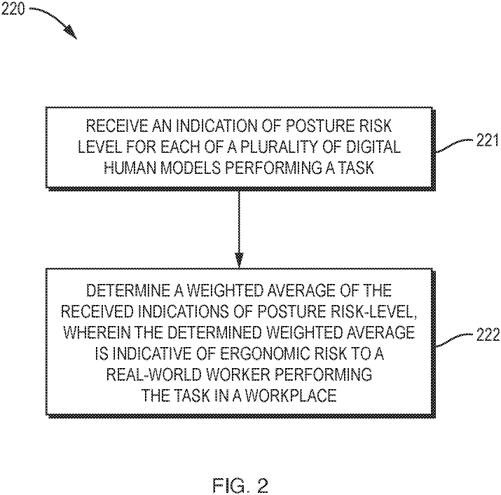

FIG. 2 is a flowchart of an example method 220 that can be used to assess ergonomic risk for each of the different levels 101-104 of the structure 100. For instance, the method 220 can be employed to assess ergonomic risk for each level of the structure 100, namely ergonomic risk of the factory 105, production line 106, workstation 107, and tasks 108 can be determined using the method 220.

The method 220 begins at step 221 by receiving an indication of posture risk level for each of a plurality of digital human models performing a task. In turn, at step 222 a weighted average of the received indications of posture risk level is determined. This determined weighted average is indicative of ergonomic risk to a real-world worker performing the task in a workplace. For instance, the digital human models represent typical humans performing the real-world task and, as such, the weighted average indicates real-world risk to a human performing the task in the real world (e.g., at a certain factory, production line, and workstation).

According to an embodiment of the method 220, each of the plurality of digital human models, for which an indication of posture risk level is received at step 221, represents a human with respective anthropometric characteristics. For instance, each digital human model may be a model representing unique anthropometric characteristics, e.g., height and weight. To illustrate, in an example embodiment of the method 220, there are four digital human models representing the statures of a 5th percentile female, 50th percentile male, 50th percentile female, and 95th percentile male (based on the population of the United States). Thus, in such an example embodiment, an indication of posture risk level is received for each model and, as such, four indications of posture risk for four humans with the foregoing anthropometries is received at step 221.

The method 220 is computer implemented and, as such, the indications of posture risk level may be received from any location, memory, or data storage, that can be communicatively coupled to a computing device implementing the method 220. In an embodiment, the indications of posture risk may include posture risk level, joint at risk, and risk type for each digital human model. Further, the indications of posture risk level received at step 221 may be determined using any known existing functionality for assessing posture risk like REBA and RULA. For example, the indications of posture risk level may be the result of a simulation performed using existing simulation software. According to another embodiment, the indications of posture risk level are determined using the functionality described in U.S. Provisional Application No. 63/287,251 filed on Dec. 8, 2021 and the corresponding non-provisional U.S. Pat. Application entitled “SYSTEMS AND METHODS FOR ASSESSING ERGONOMIC RISK,” Attorney Docket No. 4316.1025-001.

Further, the indications of posture risk level received at step 221 may be in any form that indicates posture risk. According to an embodiment, the indications received at step 221 indicate that posture risk is one of low, medium, and high. Amongst other examples, these indications may be made numerically, e.g., by receiving a number (quantitative indication) on a scale from 1 to 5, or textually, e.g., by receiving a qualitative indication of low, medium, or high.

In an example embodiment, determining the weighted average at step 222 comprises modifying/selecting weightings for each received indication of posture risk level as a function of risk level. To illustrate, consider a simple example where there are two digital human models. In such an embodiment, two indications of posture risk level are received at step 221, a high risk for the first model (indicated by a 0 on a scale of 0 to 5) and a medium risk (indicated by a 2 on the scale of 0 to 5) for the second model. When determining the weighted average at step 222, the 0 is given greater weight (4) and the 2 is given less weight (2). For this illustrative example, the weighted average is computed using the formula:

$$P o s t u r e R i s k = \frac{\sum \left(R i s k L e v e l ∗ R i s k W e i g h t\right)}{\sum R i s k W e i g h t}$$

$$P o s t u r e R i s k = \frac{\left(4 ∗ 0\right) + \left(2 ∗ 2\right)}{\left(4 + 2\right)}$$

$$P o s t u r e R i s k = 0.66$$

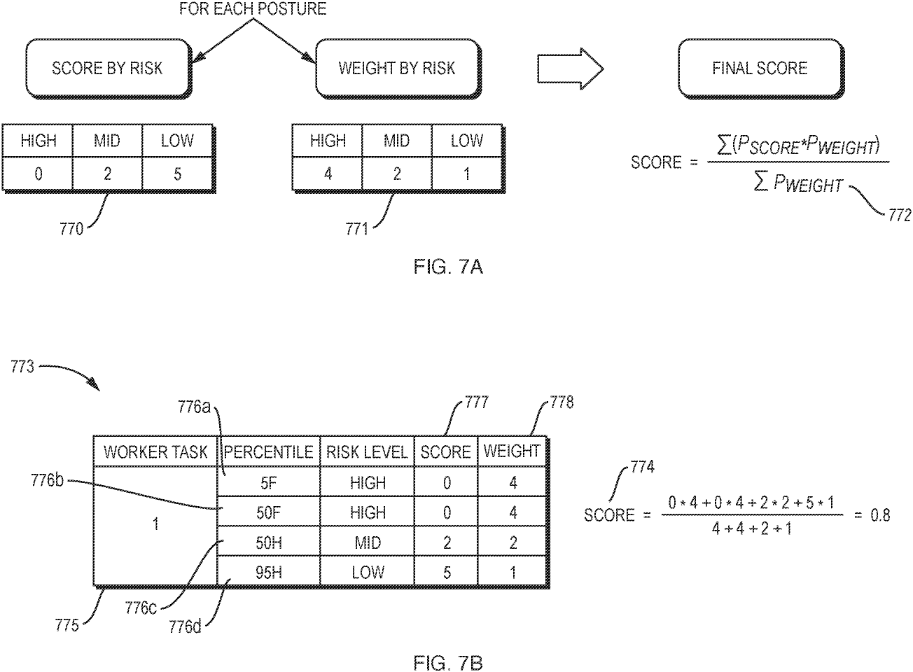

Further, embodiments of the method 220 may also determine the weighted average at step 222 using the functionality described hereinbelow in relation to FIGS. 7A-B, 8A-B, and 9A-B.

In embodiments of the method 220, the task can be one of a plurality of tasks. In such an embodiment, indications of posture risk level are received for each task, for each digital human model. Such data allows embodiments of the method 220 to assess risk at different levels of granularity. To illustrate, consider the aforementioned example where two indications of posture risk level are received at step 221, a high risk for the first model (indicated by a 0 on a scale of 0 to 5) and a medium risk (indicated by a 2 on the scale of 0 to 5) for the second model. These aforementioned indications of risk level are for a first task, and for a second task, indications of risk received at step 221 include a 0 for the first model and a 2 for the second model. The aforementioned formula can be used to determine the risk level for the first task and second task.

Further, depending on the relationship between the tasks, different risk determinations for different levels of a hierarchy, e.g., the structure 100, can be determined. The foregoing formula is used to calculate risk at each level of the hierarchy, but the data used in the formula changes depending on the relationship between tasks and the desired risk assessment. Specifically, when determining ergonomic risk for a particular level, e.g., task level 104, workstation level 103, production line level 102, and factory level 101, the worker task data for the tasks that make up the level of interest are used in the above formula. For non-limiting example, the worker task data may be stored in a data structure accessible by method 220.

For instance, if a first task and a second task are performed at the same workstation, the risk level data for both tasks is used in the formula to determine the ergonomic risk level for the workstation. However, if each task is performed at a different workstation, the data for each respective task is used to the calculate the risk for each particular workstation. This logic is applied when calculating the risk for each level of the structure, e.g., 100. If production line risk is desired, the risk level data for each worker task performed on the production line is used in the above formula and, likewise, if the factory level risk is desired, the risk level data for each worker task in the factory is used. For non-limiting example, the risk level data may be stored in a data structure accessible by method 220.

In another embodiment, respective indications of posture risk level, joint at risk, and risk type are received at step 221 for each of the plurality of digital human models. Moreover, such data (posture risk level, joint at risk, and risk type) can be received at step 221 for each digital human model for each of a plurality of worker tasks. Embodiments of the method 220 can use such data to determine risk at different levels of granularity while also considering the consecutiveness of tasks. Embodiments may also receive indications of posture risk level and joint at risk at step 221 for each of the plurality of digital human models and use such data to determine risk at different levels of granularity while also considering the consecutiveness of tasks.

For instance, in an embodiment, the plurality of tasks form an operation, i.e., a combination of tasks. An example is the task of (i) grabbing a bolt, (ii) inserting the bolt, and (iii) tightening the bolt, that make-up the complete operation of assembling two objects with a bolt. Such an embodiment determines a weighted average of the received respective indications of posture risk level at step 221. The weights utilized in determining the weighted average at step 221 are a function of the received respective indications of posture risk level, and optionally joint at risk, and risk type. In such an embodiment, the determined 222 weighted average of the received respective indications of posture risk level indicates ergonomic risk of the operation when performed by the real-world worker in the certain workplace. An embodiment of the method 220 also modifies the weights utilized in determining the weighted average if two consecutive tasks of the plurality of tasks have both (i) a posture risk level above a threshold and (ii) a same indicated joint at risk.

In another embodiment that analyzes ergonomic risk of a workstation, a first subset of the plurality of tasks form a first operation, a second subset of the plurality of tasks form a second operation. In such an embodiment, the first operation and the second operation are each performed at a certain workstation in the workplace. Such an embodiment of the method 220 determines 222 a weighted average of the received respective indications of posture risk level. The weights utilized in determining the weighted average are a function of the received respective indications of posture risk level and, optionally, joint at risk and risk type, and the determined weighted average of the received respective indications of posture risk level indicates ergonomic risk of the workstation.

Another embodiment is directed to assessing a production line. This embodiment of the method 220 analyzes a plurality of tasks that form multiple operations, wherein the multiple operations are performed across multiple workstations that make-up a certain production line in the workplace. Such an embodiment determines 222 a weighted average of the received respective indications of posture risk level. The weights utilized in determining 222 the weighted average are a function of the received respective indications of posture risk level and, optionally, joint at risk and risk type. The determined weighted average of the received respective indications of posture risk level indicates ergonomic risk of the production line.

Further still, another embodiment of the method 220 analyzes ergonomic risk for an entire factory. In such an embodiment the plurality of tasks form multiple operations and the multiple operations are performed across multiple workstations that make-up multiple production lines of said factory. A weighted average of the received respective indications of posture risk level are determined. The weights utilized in determining 222 the weighted average are a function of the received respective indications of posture risk level and, optionally, joint at risk and risk type. The determined weighted average of the received respective indications of posture risk level indicates ergonomic risk of the factory.

Further examples and methods for determining 222 weighted averages so as to assess risk for tasks, operations, work stations, production lines, and factories are described hereinbelow.

Embodiments of the method 220 may also provide various outputs indicating results of the determined 222 weighted average. For instance, an embodiment of the method 220 outputs the determined weighted average. Further, in another embodiment of the method 220, the output provided reduces ergonomic risk by causing a modification to at least one of: posture, the task, or a workstation at which the task is performed by real-world workers. For example, an embodiment may output an indication of the most at risk worker task in a certain production line and position of an object used in the worker task may be modified so as to reduce the risk.

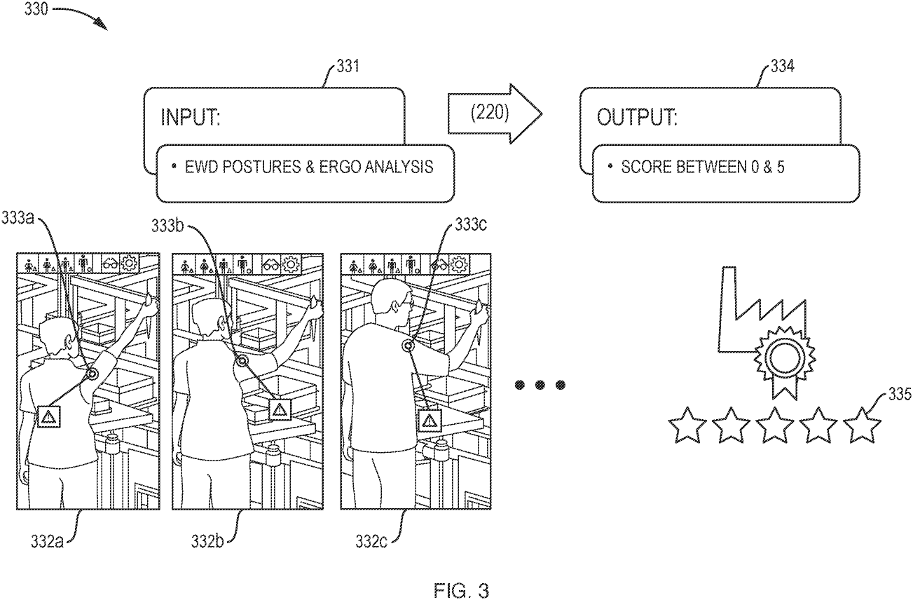

FIG. 3 is a flow diagram of another example method 330 for assessing ergonomic risk. The workflow 330 receives input 331 that includes manikin postures 332a-c and associated ergonomic analyses for each posture, e.g., the indications 333a-c that the shoulder joints are at risk. The input 331 data (postures 332a-c and risk indications 333a-c) are then processed using the methods described herein, e.g., the method 220, to generate the output 334. In the example workflow 330, the output includes a score and some indication, e.g., the star rating 335, of the score.

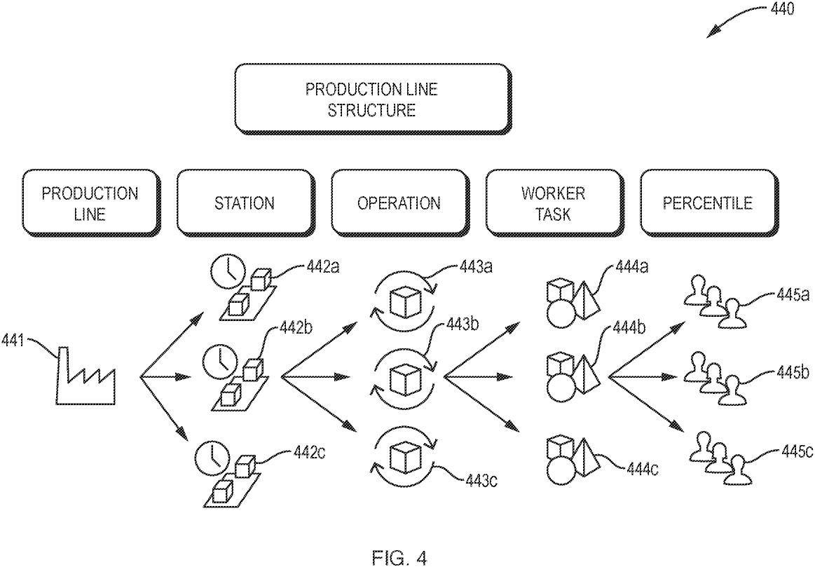

Embodiments can leverage existing software applications to generate indications of posture risk level. Amongst other examples, embodiments may utilize EWD, which uses the SPE and Ergo4All™ (i.e., embodiments described in U.S. Provisional Application No. 63/287,251 filed on Dec. 8, 2021 and the corresponding non-provisional U.S. Pat. Application entitled “SYSTEMS AND METHODS FOR ASSESSING ERGONOMIC RISK,” Attorney Docket No. 4316.1025-001) technologies. Such existing applications can be used to assess simulated worker tasks that can be part of a group of workstations, that can themselves be part of a larger unit such as a production line. FIG. 4 illustrates such a production line structure 440. The structure 440 includes the production line 441 that includes the workstations 442a-c. The workstations 442a-c are associated with one or more operations that are performed at the workstations 442a-c. FIG. 4 illustrates one example where the operations 443a-c are performed at the workstation 442b. Further, in the structure 440, operations, e.g., 443a-c are composed of worker tasks. In the illustrated structure 440, the operation 443b includes the worker tasks 444a-c. As noted above, embodiments can utilize indications of posture risk level for each of a plurality of workers performing a task. This is also illustrated in the structure 440 where indications of risk for multiple models 445a-c are identified for the task 444b. In the structure 440 each model 445a-c has anthropometric characteristics belonging to a different percentile of a population.

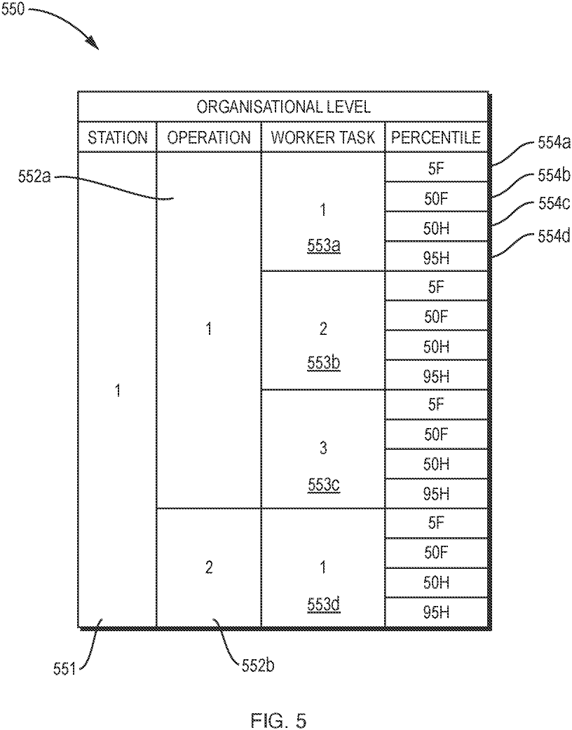

FIG. 5 illustrates another example structure 550 illustrating data that may be employed in embodiments. Specifically, the table 550 captures a hierarchy of elements that may be analyzed using embodiments. The table 550 includes a single workstation 551 where two operations 552a-b are performed. The table 550 also shows that the operation 552a includes the worker tasks 553a-c and the operation 552b includes the task 553d. Each task 553a-d has a respective risk level associated with a 5^{th} percentile female 554a, 50^{th} percentile female 554b, 50^{th} percentile male 554c, and 50^{th} percentile female 554d.

Embodiments utilize factory and production line structures, e.g., factory structure 100 and production line data structures 330, 440, 550, to generate the indications of posture risk level used in embodiments, such as the indications of posture risk level received at step 221 of the method 220. Moreover, the factory and production line data structures are used when determining the weighted averages, e.g., at step 222, to determine which risk data to utilize. For instance, consider the data structure 550. If the risk of the worker task 553a is desired, the risk level for the DHMs 554a-d is used in the formula described herein to calculate the risk of the worker task 553a. Meanwhile, if the risk for the operation 552a is desired, the percentile risk 554a-d for each worker task 553a-c is utilized.

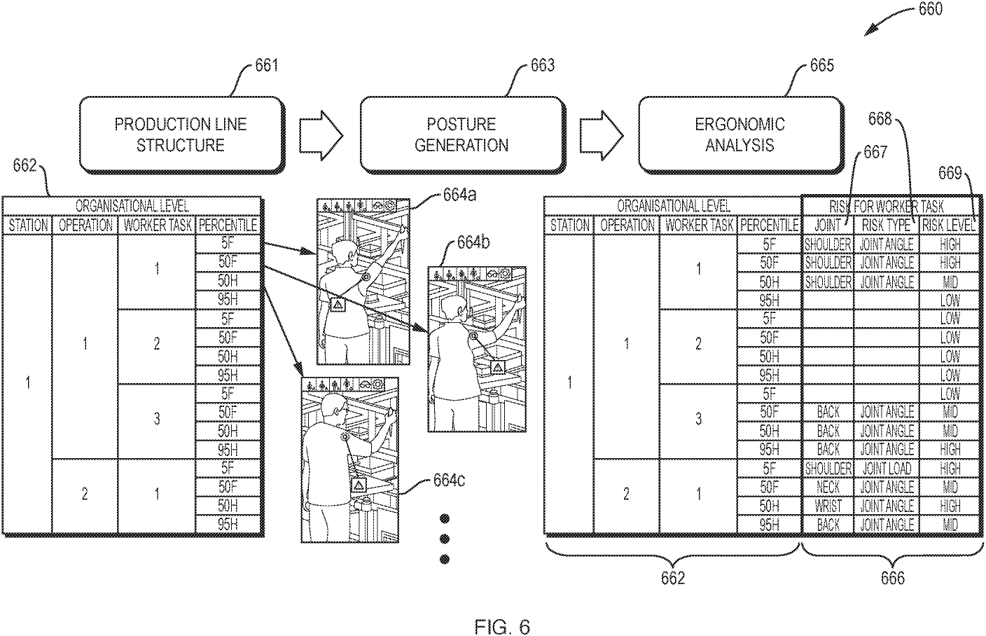

FIG. 6 illustrates an example method 660 for creating a production line structure and assessing risk of the production line structure using embodiments. The production line structure may be captured in any way desired by the user. For instance, in the example of FIG. 6, a user indicates the production line structure using a table 662 (fashioned in the same way as described above for table 550 of FIG. 5). Further, a user, e.g., an industrial engineer inputs a worker task for each of the worker tasks in the table 662. The inputted worker task, according to an embodiment, includes a definition of the task including the action performed by each hand and the objects each hand interacts with. In an embodiment, the task definition is in the form of a sentence. In such an embodiment, the sentence contains the action performed by the hand(s) and the object(s) interacting with each hand. In turn, software, such as the Smart Posturing Engine™, automatically generates 663 postures, e.g., 664a-c for multiple manikin anthropometries (e.g., respectively, 5^{th} percentile female, 50^{th} percentile female, 50^{th} percentile male, 95^{th} percentile male based on an American anthropometry database), for each worker task (Parkinson & Reed, 2010; Reed et al., 2014). Each generated 663 posture, e.g., 664a-c, is then analyzed 665 to determine an indication of ergonomic risk for each posture. In FIG. 6 the determined risk information for each posture is shown in the table 666. According to an embodiment, an existing software application, such as Ergo4All™, is used to analyze each posture 664a-c generated 663. As shown in the table 666, the analysis 665 provides three pieces of information for each worker task, the joint most at risk for the worker (back, shoulder, neck, elbow, wrist) 667, the type of risk (object weight, joint load, joint angle) 668, and the relative risk level (low, medium, high) 669.

This risk data, e.g., joint at risk 667, risk type 668, and relative risk level 669, is then used to determine weighted risk scores. In an example embodiment, weighted risk scores are determined for each worker task, operation, workstation, production line, and hierarchy. In an embodiment, the score for each posture ranges from 0 (high risk) to 5 (low risk). FIG. 7A illustrates an example formula for calculating risk of each posture. First, for each posture, a score is assigned based on the risk level, in accordance with the table 770. According to the table 770, a high risk posture is assigned score 0, a medium risk posture is assigned score 2, and a low risk posture is assigned score 5. Each posture is also assigned a weight in accordance with the table 771. Specifically, high risk postures are assigned a weight of 4, medium risk postures are assigned a weight of 2, and low risk postures are assigned a weight of 1. These scores and weightings are then used in the formula 772 to determine an indicator of the ergonomic risk of a task. It is noted that embodiments are not limited to the numerical values described herein, e.g., the tables 770 and 771. Embodiments may utilize any desired values given an indication of value meaning is provided to users, e.g., a higher score indicates lower risk, etc.

FIG. 7B illustrates an example of using the score table 770, weighting table 771, and formula 772 on the data of the table 773 to determine the score 774 for the worker task 775. In operation, the 5^{th} percentile female 776a, who has a high risk posture, is assigned a score of 0 and weight of 4. The 50^{th} percentile female 776b, who has a high risk posture, is assigned a score of 0 and weight of 4. The 50^{th} percentile male 776c, who has a medium risk posture, is assigned a score of 2 and weight of 2, and the 95^{th} percentile male 776d, who has a low risk posture, is assigned a score of 5 and weight of 1. Using these scores 777 and weights 778 in the formula 772 results in the score 774 of 0.8 for the worker task 775.

In an embodiment, the weightings, e.g., 771, attributed to the postures are based on Gallagher & Schall Jr, 2017. These authors show that the risk for MSDs increases depending on the force level and task repetition. For a low repetitive and high force task, the MSD risk is almost 4 times higher than for low repetitive and low force tasks.

In addition to the weightings 771 indicated in FIG. 7A, embodiments can use additional/different weightings to account for relationships between tasks, e.g., when two consecutive tasks both have either a high or a medium risk level for the same body joint. This approach is coherent with Gallagher & Schall Jr, 2017 who demonstrated that highly repetitive and high force tasks increase the MSD risk by 13.9 times compared to a low repetitive and low force task. By using these modified weightings, the overall scores determined by embodiments better represent risk for task sequences.

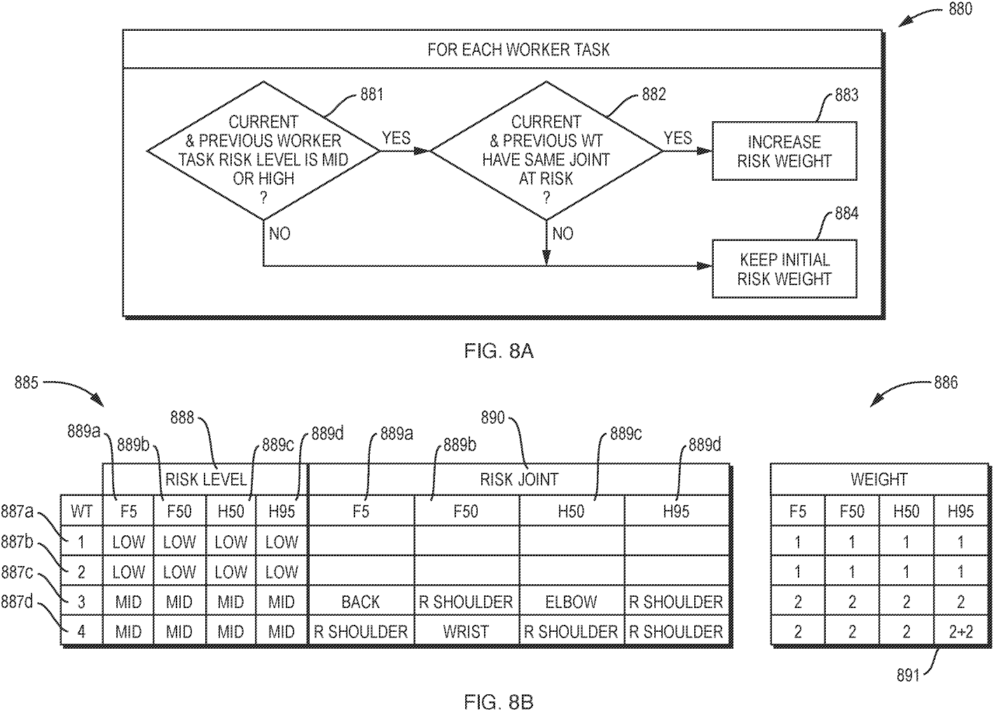

FIG. 8A is a flowchart of a method 880 for modifying weightings according to an embodiment. The method 880 modifies weightings when sequential tasks have high or medium risk associated with the same joint. According to an embodiment, the method 880 is utilized when assigning weights, e.g., 771, to risk scores, e.g., 770. First, the method 880 at step 881, determines if the current and previous worker task risk level is medium or high. If the current and previous worker task risk level is medium or high (yes at step 881), the method 880 moves to step 882. Further, if the current and previous worker task risk level are not both medium and/or high (no at step 881), the method 880 moves step 884 where the original weightings, e.g., 771, are utilized. Returning to step 882, the method 880 considers if the current and previous worker task have the same at risk joint. If the same joint is not at risk (no at step 882) the method 880 moves to step 884 where the original weightings are maintained. However, if the same joint is at risk in the current and previous task, the method 880 moves to step 883 and increases the weighting applied to the risk level.

FIG. 8B shows an example of applying the method 880 to data in the table 885 to generate the weights in the table 886. To illustrate, table 885 shows that for worker tasks 887a and 887b, the risk level 888 for each manikin 889a-d is low. As such, at step 881 of the method 880, when determining if current and previous risk level is medium or high, the answer is no for worker tasks 887a-b, which causes the method 880 to move to step 884 where typical weights, e.g., 771, are used as shown in the table 886.

Meanwhile, for the worker tasks 887c-d the risk levels 888 are all medium. When assessing worker task 887c, at step 881, it is determined that current 887c and previous 887b task risk level is not medium or high, because risk level is low for previous task 887b. Thus, for worker task 887c, the method 880 moves to step 884 and the typical weights are used as shown in table 886. The worker task 887d is analyzed at step 881 and it is determined that for each manikin 889a-d, the current 887d and previous 887c worker task risk level is medium or higher, and, the method 880 moves to step 882. The analysis at step 882 considers if the joint risk 890 for each manikin 889a-d of the current task 887d is associated with the same joint as the previous task 887c. At step 882, for manikins 889a-c it is determined that the risk is not associated with the same joint and the method 880 moves to step 883 and utilizes the standard weights, e.g., 771. However, at step 882 for manikin 889d it is determined that the joint at risk 890 is for the same joint (right shoulder) for consecutive tasks 887c-d and the method 880 moves to step 883 and increases the weight as shown in cell 891 of the table 886.

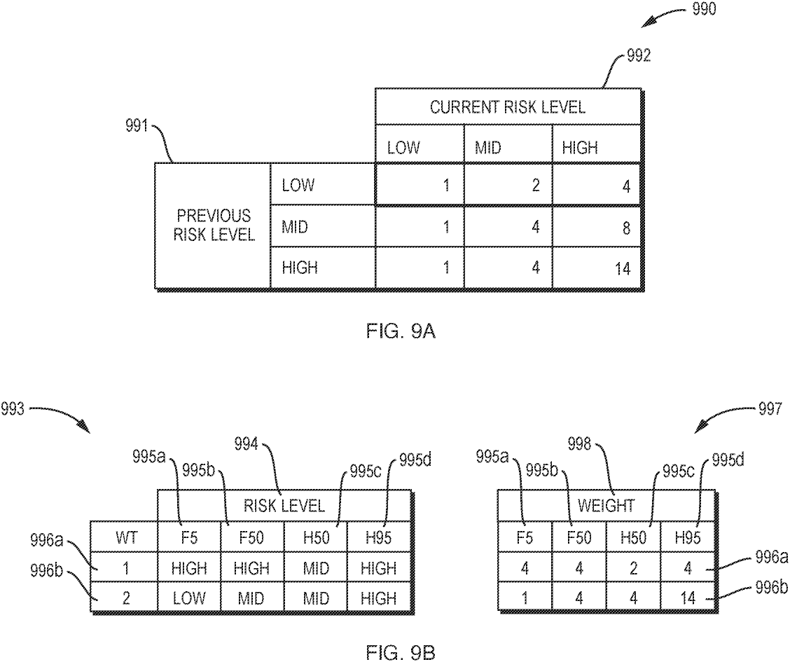

FIGS. 8A-B illustrate a method of increasing weights when two consecutive tasks have medium or high risk and the same joint is at risk in the two consecutive tasks. FIG. 9A illustrates example weights to use in such scenarios. In FIGS. 9A-B it is assumed that the risks are on the same joint. The table 990 illustrates weights to use based on different risk level combinations of previous task risk levels 991 and current task risk levels 992. In the table 990, when previous task risk level 991 is low, the weights to use are 1, 2, and 4 when current task risk levels 992 are low, medium, and high, respectively. This follows the weights shown in the table 771 described hereinabove in relation to FIG. 7A. If previous task risk level 991 is medium (i.e., mid), the weights to use are 1, 4, and 8 when current risk levels 992 are low, medium, and high, respectively. Similarly, if previous task risk level 991 is high, the weights to use are 1, 4, and 14 when current risk levels 992 are low, medium, and high, respectively.

FIG. 9B illustrates an example of using the weights shown in the table 990. FIG. 9B includes a table 993 that shows risk level 994 for various manikins 995a-d for particular worker tasks 996a-b. FIG. 9B also includes a table 997 that shows the resulting weights 998 for each manikin 995a-d for the worker tasks 996a-b, when using the table 990. For worker task 996a, it is assumed there is no previous worker task, and, as such, the resulting weights 998 are 4, 4, 2, 4, for the manikins 995a-d, respectively. This follows the weight table 771 and 990. Where there is no previous worker task the result is the same as when the previous risk is low. For worker task 996b, for manikin 995a, the weight 998 is 1 because the current risk 994 is low. For worker task 996b, for manikin 995b, the weight 998 is 4 because the current risk 994 is medium and the previous risk is high. Similarly, for worker task 996b, for manikin 995c, the weight 998 is 4 because the current risk 994 is medium and the previous risk is medium. For worker task 996b, for manikin 995d, the weight is 14 because the current risk 994 is high and the previous risk is high.

Advantageously, the scores determined by embodiments and the weights used to develop these scores are coherent with the scientific literature on MSD risk. The scores can be used as indicators for prioritization and comparison purposes.

Embodiments present a method for calculating an ergonomic risk score, e.g., a MSD risk score, for worker tasks, operations, workstations, or departments, production lines, and factories of a user, e.g., a manufacturing organization. Theses scores thus inform on the risk at different levels of the organization, that is, from the micro level of a worker task to the macro level of a production line as a whole. The risk scores can be useful to a factory director who wants to know which production lines are the most at risk, as well as to the manufacturing engineer who wants to identify worker tasks at risk. Theses scores provide valuable information to support decisions aimed at enhancing worker health and safety. For instance, responsive to these scores, real-world actions can be made to improve worker safety. Amongst other examples, a rig or lifting device could be added to a workstation or workstation layout or the product design can be changed.

Embodiments provide functionality that aggregates non-homogenous variables, e.g., indications of at risk joints, risk levels, and risk types, to determine a risk score. Further, by considering consecutiveness, e.g., increasing weights for consecutive high/medium risk tasks, embodiments also consider user fatigue.

### Computer Support

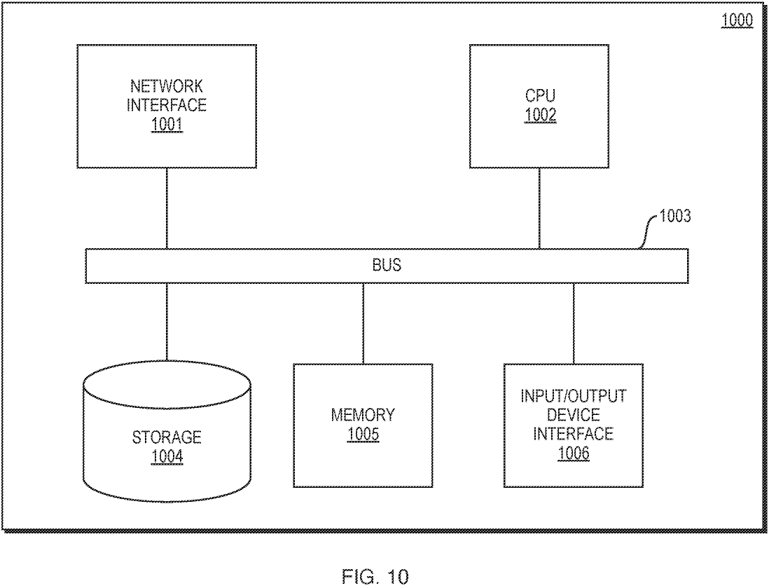

FIG. 10 is a simplified block diagram of a computer-based system 1000 that may be used to assess ergonomic risk according to any variety of the embodiments of the present invention described herein. The system 1000 comprises a bus 1003. The bus 1003 serves as an interconnect between the various components of the system 1000. Connected to the bus 1003 is an input/output device interface 1006 for connecting various input and output devices such as a keyboard, mouse, display, speakers, etc. to the system 1000. A central processing unit (CPU) 1002 is connected to the bus 1003 and provides for the execution of computer instructions. Memory 1005 provides volatile storage for data used for carrying out computer instructions. In particular, memory 1005 and storage 1004 hold computer instructions and data (databases, tables, etc.) for carrying out the methods described herein, e.g., 220, 330, 660, 880 of FIGS. 2, 3, 6, and 8, and supporting corresponding user interfaces described above. Storage 1004 provides non-volatile storage for software instructions, such as an operating system (not shown). The system 1000 also comprises a network interface 1001 for connecting to any variety of networks known in the art, including wide area networks (WANs) and local area networks (LANs).

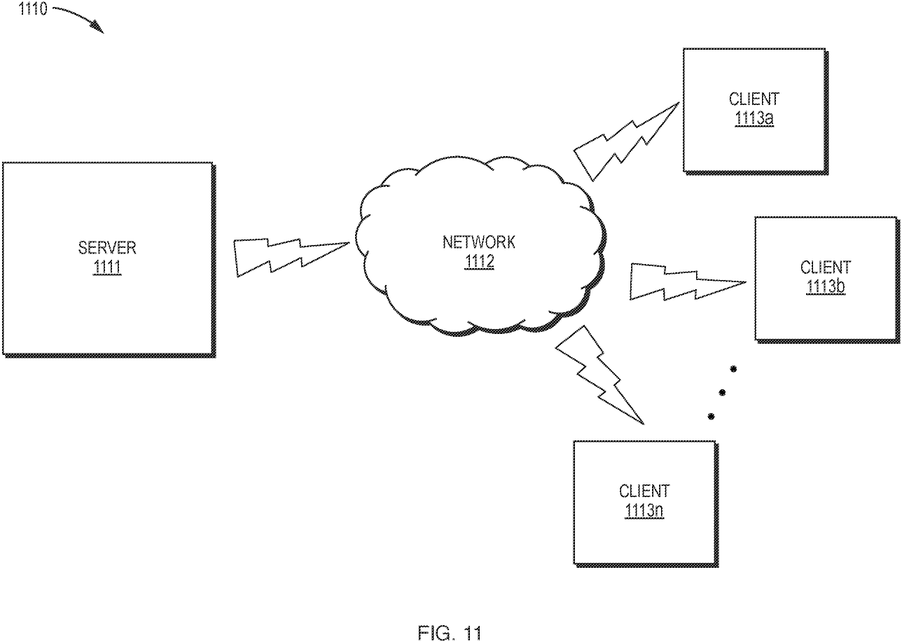

It should be understood that the example embodiments described herein may be implemented in many different ways. In some instances, the various methods and machines described herein may each be implemented by a physical, virtual, or hybrid general purpose computer, such as the computer system 1000, or a computer network environment such as the computer environment 1110, described herein below in relation to FIG. 11. The computer system 1000 may be transformed into the machines that execute the methods (e.g., 220, 330, 660, and 880) and techniques described herein, for example, by loading software instructions into either memory 1005 or non-volatile storage 1004 for execution by the CPU 1002. One of ordinary skill in the art should further understand that the system 1000 and its various components may be configured to carry out any embodiments or combination of embodiments of the present invention described herein. Further, the system 1000 may implement the various embodiments described herein utilizing any combination of hardware, software, and firmware modules operatively coupled, internally, or externally, to the system 1000.

FIG. 11 illustrates a computer network environment 1110 in which an embodiment of the present invention may be implemented. In the computer network environment 1110, the server 1111 is linked through the communications network 1112 to the clients 1113a-n. The environment 1110 may be used to allow the clients 1113a-n, alone or in combination with the server 1111, to execute any of the embodiments described herein. For non-limiting example, computer network environment 1110 provides cloud computing embodiments, software as a service (SAAS) embodiments, and the like.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

### References

Gallagher, S., & Schall Jr, M. C. (2017). Musculoskeletal disorders as a fatigue failure process: evidence, implications and research needs. Ergonomics, 60(2), 255-269.

Hignett, S., & McAtamney, L. (2000). Rapid entire body assessment (REBA). Applied Ergonomics, 31(2), 201-205.

Lemieux, P.-O., Barré, A., Hagemeister, N., & Aissaoui, R. (2017). Degrees of freedom coupling adapted to the upper limb of a digital human model. International Journal of Human Factors Modelling and Simulation, 5(4), 314-337.

Lemieux, P., Cauffiez, M., Barré, A., Hagemeister, N., & Aissaoui, R. (2016). A visual acuity constraint for digital human modeling. Conference proceedings. 4th International Digital Human Modeling Symposium (DHM2016)

McAtamney, L., & Corlett, E. N. (1993). RULA: a survey method for the investigation of workrelated upper limb disorders. Applied ergonomics, 24(2), 91-99.

Parkinson, M. B., & Reed, M. P. (2010). Creating virtual user populations by analysis of anthropometric data. International Journal of Industrial Ergonomics, 40(1), 106-111.

Reed, M. P., Raschke, U., Tirumali, R., & Parkinson, M. B. (2014). Developing and implementing parametric human body shape models in ergonomics software.

Proceedings of the 3rd international digital human modeling conference, Tokyo, Zeighami, A., Lemieux, P., Charland, J., Hagemeister, N., & Aissaoui, A. (2019). Stepping behavior for stability control of a digital human model. ISB/ASB.

What is claimed is:

1. A computer-implemented method for assessing ergonomic risk of causing harm to a worker in a workplace, the method comprising, by a processor:
receiving an indication of posture risk level for each of a plurality of digital human models performing a task; and
determining a weighted average of the received indications of posture risk level, wherein the determined weighted average is indicative of ergonomic risk to a real-world worker performing the task in a workplace.

2. The method of claim 1 wherein each of the plurality of digital human models represents a human with respective anthropometric characteristics.

3. The method of claim 1 wherein determining the weighted average comprises:
modifying weightings of each received indication of posture risk level as a function of risk level.

4. The method of claim 1 wherein the task is one of a plurality of tasks and, the method further comprises:
for each of the plurality of tasks, receiving respective indications of posture risk level and joint at risk, for each of the plurality of digital human models.

5. The method of claim 4 wherein the plurality of tasks form an operation and the method further comprises:
determining a weighted average of the received respective indications of posture risk level, wherein (i) weights utilized in determining the weighted average are a function of the received respective indications of posture risk level and joint at risk and (ii) the determined weighted average of the received respective indications of posture risk level indicates ergonomic risk of the operation when performed by the real-world worker in the workplace.

6. The method of 5 further comprising:
modifying the weights utilized in determining the weighted average if two consecutive tasks of the plurality of task have both (i) a posture risk level above a threshold and (ii) a same indicated joint at risk.

7. The method of claim 4 wherein a first subset of the plurality of tasks form a first operation, a second subset of the plurality of tasks form a second operation, and the first operation and the second operation are each performed at a workstation in the workplace, the method further comprising:
determining a weighted average of the received respective indications of posture risk level, wherein (i) weights utilized in determining the weighted average are a function of the received respective indications of posture risk level and joint at risk and (ii) the determined weighted average of the received respective indications of posture risk level indicates ergonomic risk of the workstation.

8. The method of claim 4 wherein the plurality of tasks form multiple operations and the multiple operations are performed across multiple workstations that make-up a production line in the workplace, the method further comprising:
determining a weighted average of the received respective indications of posture risk level, wherein (i) weights utilized in determining the weighted average are a function of the received respective indications of posture risk level and joint at risk and (ii) the determined weighted average of the received respective indications of posture risk level indicates ergonomic risk of the production line.

9. The method of claim 4 wherein the plurality of tasks form multiple operations and the multiple operations are performed across multiple workstations that make-up multiple production lines of a real-world factory, the method further comprising:
determining a weighted average of the received respective indications of posture risk level, wherein (i) weights utilized in determining the weighted average are a function of the received respective indications of posture risk level and joint at risk and (ii) the determined weighted average of the received respective indications of posture risk level indicates ergonomic risk of the factory.

10. The method of claim 1 further comprising:
outputting the determined weighted average, wherein the outputting is in a manner effecting reduction of the ergonomic risk by causing a modification to at least one of: posture, the task, or a workstation at which the task is performed by real-world workers.

11. A system for assessing ergonomic risk of causing harm to a worker in a workplace, the system comprising:
a processor; and
a memory with computer code instructions stored thereon, the processor and the memory, with the computer code instructions, being configured to cause the system to:
receive an indication of posture risk level for each of a plurality of digital human models performing a task; and
determine a weighted average of the received indications of posture risk level, wherein the determined weighted average is indicative of ergonomic risk to a real-world worker performing the task in a workplace.

12. The system of claim 11 wherein each of the plurality of digital human models represents a human with respective anthropometric characteristics.

13. The system of claim 11 wherein, in determining the weighted average, the processor and the memory, with the computer code instructions, are further configured to cause the system to:
modify weightings of each received indication of posture risk level as a function of risk level.

14. The system of claim 11 wherein the task is one of a plurality of tasks and, the processor and the memory, with the computer code instructions, are further configured to cause the system to:
for each of the plurality of tasks, receive respective indications of posture risk level and joint at risk for each of the plurality of digital human models.

15. The system of claim 14 wherein the plurality of tasks form an operation and, the processor and the memory, with the computer code instructions, are further configured to cause the system to:
determine a weighted average of the received respective indications of posture risk level, wherein (i) weights utilized in determining the weighted average are a function of the received respective indications of posture risk level and joint at risk and (ii) the determined weighted average of the received respective indications of posture risk level indicates ergonomic risk of the operation when performed by the real-world worker in the workplace.

16. The system of claim 15 wherein the processor and the memory, with the computer code instructions, are further configured to cause the system to:
modify the weights utilized in determining the weighted average if two consecutive tasks of the plurality of task have both (i) a posture risk level above a threshold and (ii) a same indicated joint at risk.

17. The system of claim 14 wherein a first subset of the plurality of tasks form a first operation, a second subset of the plurality of tasks form a second operation, and the first operation and the second operation are each performed at a workstation in the workplace, and the processor and the memory, with the computer code instructions, are further configured to cause the system to:
determine a weighted average of the received respective indications of posture risk level, wherein (i) weights utilized in determining the weighted average are a function of the received respective indications of posture risk level and joint at risk and (ii) the determined weighted average of the received respective indications of posture risk level indicates ergonomic risk of the workstation.

18. The system of claim 14 wherein the plurality of tasks form multiple operations and the multiple operations are performed across multiple workstations that make-up a production line in the workplace, and the processor and the memory, with the computer code instructions, are further configured to cause the system to:
determine a weighted average of the received respective indications of posture risk level, wherein (i) weights utilized in determining the weighted average are a function of the received respective indications of posture risk level and joint at risk and (ii) the determined weighted average of the received respective indications of posture risk level indicates ergonomic risk of the production line.

19. The system of claim 14 wherein the plurality of tasks form multiple operations and the multiple operations are performed across multiple workstations that make-up multiple production lines of a real-world factory, and the processor and the memory, with the computer code instructions, are further configured to cause the system to:
determine a weighted average of the received respective indications of posture risk level, wherein (i) weights utilized in determining the weighted average are a function of the received respective indications of posture risk level and joint at risk and (ii) the determined weighted average of the received respective indications of posture risk level indicates ergonomic risk of the factory.

20. A non-transitory computer program product for assessing ergonomic risk of causing harm to a worker in a workplace, the computer program product executed by a server in communication across a network with one or more client and comprising:
a computer readable medium, the computer readable medium comprising program instructions which, when executed by a processor, causes the processor to:
receive an indication of posture risk level for each of a plurality of digital human models performing a task; and
determine a weighted average of the received indications of posture risk level, wherein the determined weighted average is indicative of ergonomic risk to a real-world worker performing the task in a workplace.
